(19) United States
(12) Patent Application Publication
(10) Pub. No.: US 2024/0123651 A1
(43) Pub. Date: Apr. 18, 2024

(54) MODIFICATION ARRANGEMENT FOR HYGROSCOPIC MATERIAL

(71) Applicant: AVANT WOOD OY, Kuopio (FI)

(72) Inventors: Pekka RITVANEN, Kuopio (FI); Jyrki LEHTINEN, Haukivuori (FI); Timo PASANEN, Kuopio (FI); Kari SÄYNEVIRTA, Kuopio (FI); Kari TEUVO, Kuopio (FI)

(21) Appl. No.: 18/277,377

(22) PCT Filed: Feb. 9, 2022
(86) PCT No.: PCT/FI2022/000002

§ 371 Date: Aug. 15, 2023

(30) Foreign Application Priority Data
Feb. 15, 2021 (FI) 20217032

(51) Int. Cl. B27K 3/02; B27K 3/16; B27K 3/22; B27K 3/26; B27K 3/28; B27K 5/00; F26B 5/14

(52) U.S. Cl. CPC B27K 3/0214; B27K 3/163; B27K 3/22; B27K 3/26; B27K 3/28; B27K 5/001; B27K 5/0085; F26B 5/14; B27K 2240/10; B27K 2240/20; B27K 2240/30; F26B 9/06

(57) ABSTRACT

An invention relates to thermal or thermomechanical processing of hygroscopic material to adjust the material properties. The invention concerns a modification arrangement for the hygroscopic material. The modification arrangement comprises a modification unit (202) and a fluid container (204) that is coupled with a control valve (205) to at least one fluid aperture (203). The modification arrangement is configured for heating the hygroscopic material in the modification unit (202) to extract water from it and, in response to opening of the control valve (205), leading fluid from the fluid container through said at least one fluid aperture (203) into the modification unit (202). The modification arrangement further comprises a treatment agent (207) added to the fluid so that the treatment agent (207) is absorbed into the hygroscopic material and modifies it. The treatment agent (207) includes at least one of the following ingredients: a preservative, a dye, a pigment, an aroma, an odour eliminator, a pesticide, an impregnation ingredient, or a fire retardant.

Area of technology: an invention relates to thermal or thermomechanical processing of hygroscopic material to adjust the material properties.

### BACKGROUND OF THE TECHNOLOGY

Hygroscopic material readily attracts water from its surroundings, either through absorption or through adsorption. Wood is a versatile of hygroscopic material for various purposes. Instead of wood, hygroscopic substance may comprise, for example, plants, including woody plants, cellulose fibres, cotton, paper, honey, ethanol, methanol, or concentrated sulfuric acid. Wood and woody plants are hereafter referred as wood.

Wood treatment methods are categorised to mechanical, physical, biological, and chemical methods. Sawing, splitting, and pressurising, i.e. applying an exertion of force upon wood, are examples of mechanical treatment methods.

Drying is a physical treatment method for wood. Heating is another physical treatment method and it essentially shrinks timber and decelerates decaying of the timber. Timber is considered herein as a processed wood product, while lumber is less processed wood, such as cut trees. Heating in high-temperature may reduce so-called wear resistance properties of the timber, which causes cracking. Steaming is a physical wood treatment method that prevents or inhibits said timber cracking.

Sprinkling or ponding is an example of a biological treatment method. This kind of wet storing of wood is utilized at pulp and paper mills near the coast where brackish water is available. Biological treatment methods, which are based on use of fungi, bacteria, or enzyme, are tested in laboratories and some of the methods are piloted.

Use of preservative is one of the chemical treatment methods. A certain fungi type causes decaying of wood. Preservative protects wood against fungi, spores, insects, and/or marine bores. The preservative is spread on the surface of wood, for example, by using a paintbrush. Use of a penetration-enhancing agent is another example of the chemical treatment method for hygroscopic materials. An impregnation method is based on use of resins, or corresponsive substances, and therefore it is categorized to chemical treatment methods. The resins are slightly viscous, organic liquids, which may contain formaldehyde.

Some wood treatment methods are combinations of different types of methods. For example, pressure impregnation of wood is such method that is based on chemical preservative as well as pressure, in more detail, hydraulic pressure.

The pressure impregnation of wood is performed in the following manner in an impregnation chamber. First, the timber made of wood is loaded into the impregnation chamber and vacuum created therein empties the timber cells of air. Secondly, the timber is flooded in preservative. Thirdly, preservative is forced into the timber using hydraulic pressure such that excess pressure inside the impregnation chamber. Fourthly, a vacuum is created again to remove excessive preservative from the timber. Lastly, the timber is dried in the impregnation chamber to result in the final moisture content for the timber.

TMTM (Thermo-Mechanical Timber Modification) process is developed in a company named “Avant wood” and it represents close prior art for the invention. TMTM process includes heating of hygroscopic material in a modification unit comprising a modification unit. In more detail, the process includes the following five phases to be performed in a modification unit included in the modification unit.

1. Heating of timber starts in the modification unit and a mechanical pressure is applied to the timber. The heating may cause cracking and/or other kind of timber damaging during the process and water is used to avoid the timber damaging.

2. Removal of water and densification of wood is the next process phase. The heating as well as the mechanical pressure result in the removal of water from the timber. The predetermined moisture content of wood and an appropriate temperature are needed for said densification.

3. Thermal modification is a process phase that reduces the moisture content of the timber and improves dimensional stability of the timber.

4. Cooling the timber means that water is used for the cooling to prevent such timber (drying) defects that may appear after wood modification processes.

5. Moisture content stabilization to achieve desired moisture content for the timber. Finally, the timber is released from the mechanical pressure and the process ends.

TMTM process significantly improves the quality of timber, such as timber strength and hardness. The process improves the dimensional stability and the permeability of the timber. TMTM process results in higher density on the timber surface, or alternatively, it results in higher density through the timber. In both cases the surface abrasion resistance of the timber increases. Different wood species, or woody plants, can be treated differently in TMTM process and the process enables production of customer-specific timber products.

As described in the above, impregnation is one of chemical treatment methods for wood and also the pressure impregnation is a known wood treatment method.

One drawback of the prior art is that the pressure impregnation requires quite much energy because of the need to create vacuum at least once, and excess pressure at least once, inside the impregnation chamber. The use of energy causes costs and energy production usually causes CO₂ emissions. An inexpensive and environment friendly arrangement for wood impregnation would increase usability of wood.

### SUMMARY OF THE INVENTION

An aspect of the invention is solve said drawback of the prior art and save energy by avoiding the pressure impregnation.

An aspect of the invention is to modify the properties of hydroscopic material in more versatile manners by further developing TMTM (Thermo-Mechanical Timber Modification) process.

An aspect of the invention is to treat timber in such manner that after the process the timber has predetermined measures. In other words, timber material is not wasted.

An aspect of the invention is to utilize an appropriate moment in the modification process of hydroscopic material. As known, heating dries timber, i.e. the heating decreases of its moisture content. The decrease of the moisture content results in that the timber is prone to absorb fluid in itself. In other words, the timber is susceptible to intake moisture. This is one appropriate moment to modify the timber properties and therefore the fluid having certain ingredient is led into the in a modification unit that contains the timber.

The fluid includes water in some form or solvent. The fluid further includes certain ingredient, such as preservative, added into the fluid. When timber is prone to absorb fluid, the preservative penetrates with the fluid deep into the timber. Instead of wood, cellulose fibres, cotton, or some other hydroscopic material can be modified in the modification unit.

Instead of the preservative, or in addition to it, e.g. a dye, a pigment, an impregnation ingredient, or a fire retardant can be used as a treatment agent. Because the treatment agent is added into the fluid, the treatment agent penetrates with the fluid to the hydroscopic material, and modifies the material properties.

The invention concerns a modification arrangement for hygroscopic material, the modification arrangement comprising a modification unit, at least one fluid aperture in the modification unit, and a fluid container that is coupled with a control valve to said at least one fluid aperture. The modification arrangement is configured for
heating the hygroscopic material in the modification unit to extract water from the hygroscopic material and, in response to opening of the control valve,
leading fluid from the fluid container through said at least one fluid aperture into the modification unit.

The modification arrangement further comprises a treatment agent added to the fluid so that inside the modification unit the treatment agent is absorbed, along with the fluid, into the hygroscopic material and modifies the hygroscopic material, and the treatment agent includes at least one of the following ingredients: a preservative, a dye, a pigment, an aroma, an odour eliminator, a pesticide, an impregnation ingredient, a fire retardant.

### BRIEF DESCRIPTION OF THE DRAWINGS

For a more complete understanding of examples and embodiments of the present invention, reference is now made to accompanying drawings in which:

FIG. 1 shows the moment when hygroscopic material is very prone to absorb fluid,

FIG. 2 shows a modification arrangement for hygroscopic material,

FIG. 3 shows an example of a modification unit and the modification arrangement,

FIG. 4 shows an example of a timber modification arrangement,

FIG. 5 shows leading a water-soluble treatment agent into a modification unit,

FIG. 6 shows leading a treatment agent in aerosol form into a modification unit,

FIG. 7 shows mixing of water and a treatment agent before a modification unit.

### DETAILED DESCRIPTION OF THE INVENTION

It is appreciated that the following embodiments are exemplary. Although the specification may refer to “one” embodiment, the reference is not necessarily made to the same embodiment(s), or the feature in question may apply to multiple embodiments.

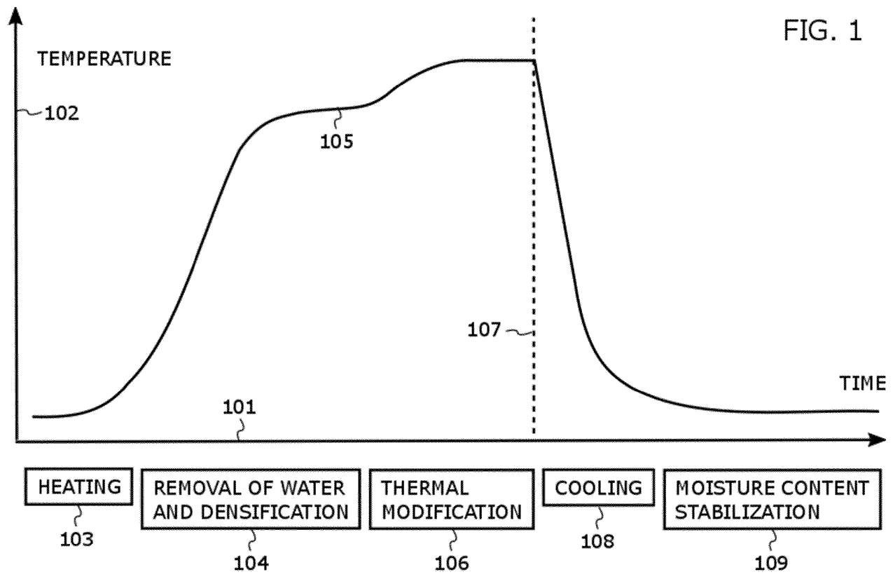

FIG. 1 illustrates a modification process in accordance with the invention and it shows a point of time when hygroscopic material is very prone to absorb fluid. A number of factors affect the modification process. For example, what kind of hygroscopic material is to be processed? The hygroscopic material is e.g. a piece of cotton textile that is folded in a stack, or a portion of cellulose fibres in a net sack, or a timber stack. If the material is timber, the modification process can be adjusted on the basis on the species of tree, for example, in such manner that the process duration and the temperature within the process are different for different species of tree. X-axis 101 shows the process duration in time and Y-axis 102 shows the temperature. The process duration for wood is usually 6-38 hours and the temperature is usually at most 200 C. °. The modification process is divided into five phases as TMTM process described in the background of the invention but in one embodiment the modification process is missing all kind of mechanical pressure.

Heating 103 of hygroscopic material is the first process phase. The hygroscopic material is placed into a modification unit and the heating starts thereat. If the hygroscopic material is timber, liquid water or steam can be led into the modification unit to avoid the timber damaging. If watering or steaming is used, the moisture content of the hygroscopic material raises and may reach its highest point.

The timber is may be also applied the mechanical pressure, which means, for example, that a hydraulic press applies force upon the hygroscopic material. Conversely than in TMTM process, the mechanical pressure is an option in the modification process in accordance with the invention.

Removal of water and densification 104 is the next process phase. The watering or steaming (if used at all) has been stopped. At least the heating and possibly the mechanical pressure result in the removal of water from the hygroscopic material and the removal of water causes the densification of the hygroscopic material. A temperature curve 105 illustrates the temperature during the modification process.

Thermal modification 106 is the process phase when the temperature has reached its highest point and the hygroscopic material is extremely dry. In other words, its moisture content is low and thus the hygroscopic material is very prone to absorb any fluid. A time moment 107 is the moment when the cooling of the hygroscopic material begins. In TMTM process the cooling is performed with water. An essential difference between the processes is that in TMTM process steam includes only water. Conversely, in the modification process in accordance with the invention, the steam may include a treatment agent.

Because of the treatment agent, there are lot of possibilities to affect the hygroscopic material properties. For example, the material can be coloured with a dye or a pigment, and alternatively or in addition, the material durability can be increased with a preservative, a pesticide, or an impregnation ingredient. The pesticide is an ingredient or mixture that kills pests, or prevents or reduces the damage the pests may cause. The pests are, for example, insects, mice or other animals, unwanted plants (weeds), fungi, bacteria or viruses. The odour of heat treated wood may distract people, thus in some embodiments the treatment agent includes an odour eliminator (an antibromic) and/or an aroma.

Adding water into the modification unit ends thermal modification 106 phase. In one embodiment, time moment 107 is determined on the basis of a hygroscope measurement result obtained from the modification unit.

Cooling 108 starts because of the water added into the modification unit. The heating is already stopped or it will be stopped in this phase. Temperature curve 105 illustrates the lowering temperature.

Moisture content stabilization 109 is the last process phase. Passing of time causes that the hygroscopic material achieves predetermined moisture content. If the mechanical pressure is applied to the hygroscopic material, the hygroscopic material is released from it. Finally, the hygroscopic material is removed from the modification unit.

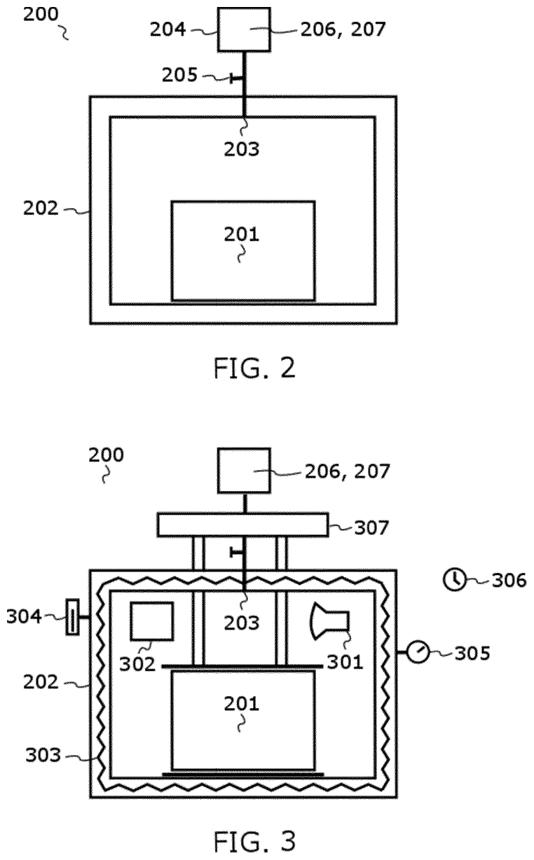

FIG. 2 shows a modification arrangement 200 for hygroscopic material 201. Modification arrangement 200 enables the modification process illustrated in the previous figure. Modification arrangement 200 comprises a modification unit 202, at least one fluid aperture 203 in modification unit 202, and a fluid container 204. The figure shows a cross-section of modification unit 202 and fluid container 204.

In one embodiment modification unit 202 is made of multiple layers of bricks and it has a shape of cubic and fluid container 204 has a shape of barrel. In one embodiment modification unit 202 has a door for placing hygroscopic material 201 into modification unit 202 and for taking hygroscopic material 201 out of it (the door is omitted from the figure). In one embodiment modification unit 202 is a drying oven that is able to heat air and circulate the air heated inside modification unit 202.

Fluid container 204 is coupled with a control valve 205 to at least one fluid aperture 203. Modification arrangement 200 is configured to perform the following in the modification process: heating hygroscopic material 201 in modification unit 202 to extract water from it, and then, in response to opening of control valve 205, leading fluid 206 from fluid container 204 through at least one fluid aperture 203 into modification unit 202.

Modification arrangement 200 further comprises a treatment agent 207 added to fluid 206. In one embodiment treatment agent 207 is first added in liquid form to water and then the water and treatment agent 207 are boiled such that they both are changed from liquid form to gas form. In one embodiment fluid container 204 has an electrical resistance for boiling water and treatment agent 207. In one embodiment, fluid container 204 is a pressure vessel and fluid 206 includes superheated steam, i.e. the steam has a temperature higher than its boiling point in the pressure prevailing in fluid container 204.

Assuming that the mass of hygroscopic material 201 is known and the heating capacity of modification unit 202 is known it is possible to estimate the time moment when hygroscopic material 201 is prone enough to absorb fluid 206.

In many embodiments measurement data is utilized to determine an appropriate time moment to open control valve 205. In one embodiment control valve 205 is manually opened and closed. In another embodiment the modification process is automated such that a computer opens and closes control valve 205 using a motor.

Nevertheless, in response to opening of control valve 205, fluid 206 ends into modification unit 202 and treatment agent 207 is absorbed, along with fluid 206, into hygroscopic material 201 modifying it. The content of treatment agent 207 specifies in which manner hygroscopic material 201 is modified. Treatment agent 207 includes at least one of the following ingredients: a preservative, a dye, a pigment, an aroma, an odour eliminator, a pesticide, an impregnation ingredient, a fire retardant. For example, if treatment agent 207 includes the preservative as well as the dye, the dye changes the color of hygroscopic material 201 and the preservative protects it from decaying, mildewing, or another type of defect.

FIG. 3 is a cross-section figure that shows an example of modification unit 202 and the modification arrangement. In one embodiment modification arrangement 200 comprises a blower 301 and a heater 302 and for heating hygroscopic material 201 inside modification unit 202 such that blower 301 is able to blow air towards heater 302. Modification unit 202 comprises a thermal insulation layer 303 to avoid heat leaks.

In one embodiment modification arrangement 200 comprises at least one of the following meters to determine a time moment for leading fluid 206 and treatment agent 207 into modification unit: a thermometer 304 in modification unit 202, a hygrometer 305 in modification unit 202, a clock 306.

In one embodiment modification arrangement 200 comprises a compression apparatus 307 to apply an exertion of force upon hygroscopic material 201 such that water is extracted from hygroscopic material 201. In one embodiment compression apparatus 307 is a hydraulic press, or another type of mechanical press.

In one embodiment, modification arrangement 200 comprises rails, rollers, or some other mechanical arrangement for moving hygroscopic material 201 into modification unit 202 and out of it.

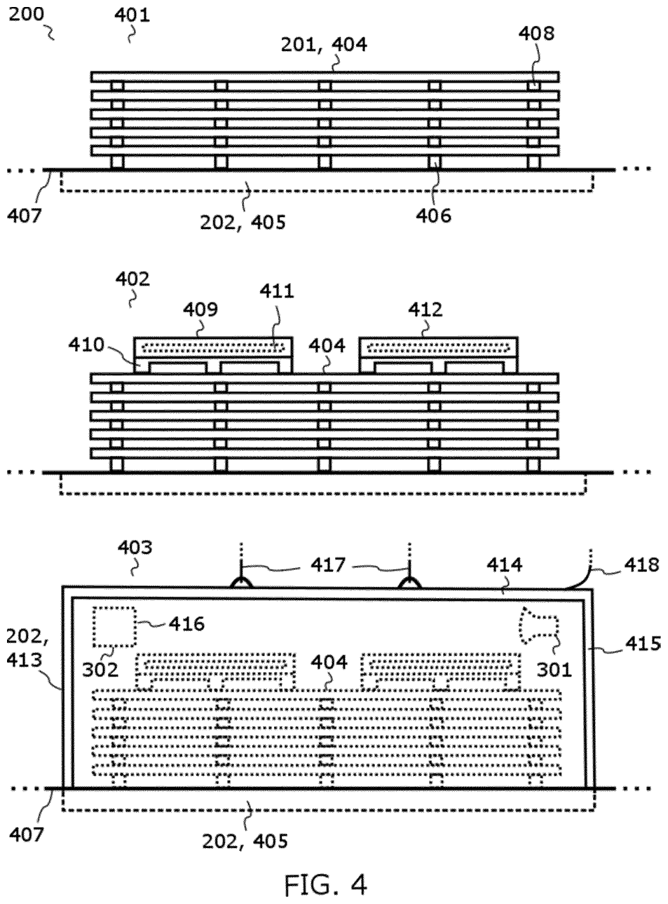

FIG. 4 shows an example of modification arrangement 200 in three views 401-403. Hygroscopic material 201 is here a timber stack 404 that includes the same size of sawn timber pieces, such as planks or boards. In one embodiment the timber pieces have predetermined measures before use of modification arrangement 200 that causes shrinking of timber pieces. Because the shrink degree is known, the use of modification arrangement 200 results in timber pieces that have final predetermined measures.

In other words, there is no need to saw or plane the timber pieces to be sold to customers. This benefit of modification arrangement 200 saves timber material and reduces a labour need. In one embodiment the timber pieces get preservative and final colour in modification arrangement 200. Then the timber pieces are ready to be used, for example, in a terrace construction, or in a sheathing of a house.

Timber stack 404 is viewed from its side in the all views 401-403.

First view 401 shows timber stack 404 laid on a bottom part 405 of modification unit 202. In this embodiment, modification unit 202 is composed of two detachable parts. Bottom part 405 comprises support pieces, such as a support piece 406, on which timber stack 404 is laid, for example, by using a forklift. Bottom part 405 is illustrated with a dashed line and it is sank into a floor 407 made of concrete. Layers of timber stack 404 are separated from each other with wooden battens, for example, with a batten 408. Because of the battens, fluid can enter between the layers of timber stack 404 and affect each timber piece.

Second view 402 shows timber stack 404 when a weight 409 is placed on it. Weight 409 causes an exertion of force upon timber stack 404 to extract water from the timber stack 404. Gravitation force is the same all the time, thus weight 409 provides the same exertion of force during modification arrangement 200. Weight 409 comprises a pallet 410 made of plastics, an iron plate, which functions as weigh material 411 (shown with a dotted line), and thermal insulation (not shown) around weight material 411. Because of the thermal insulation, the heating energy is not wasted to heating of weight material 411. In one embodiment EPS (expanded polystyrene) is used as the thermal insulation and its outer surface is protected with a fiberglass shell. Weight 409 comprising pallet 410 is moveable on timber stack 404, for example, by a forklift. At least one other corresponding weight 412 is laid on timber stack 404 for the thermomechanical timber processing.

Third view 403 shows a top part 413 of modification unit 202 that is laid on bottom part 405 and is detachable from it. Timber stack 404 and other objects inside modification unit 202 are illustrated with a dotted line. Top part 413 comprises a roof 414 to which four walls, such as a wall 415, are attached. Top part 413 has a space for heater 302 and blower 301. The space is needed for at least one heater and blower at proximity of roof 414. In one embodiment heater 302 is an electrical resistance pack 416.

As shown in third view 403, top part 413 is coupled with steel wires 417 to an electric winch that is attached to the ceiling of a building and is capable to lift top part 413 (the electric winch and the ceiling are omitted from the figure). Top part 413 is further coupled with an electric wire 418 to mains power so that e.g. heater 302 and blower 301 in top part 413 are usable. A benefit of this embodiment is that several modification units, such as modification unit 202, can be placed very close to each other on a hall floor and thus a great amount of timber can be simultaneously processed in the hall.

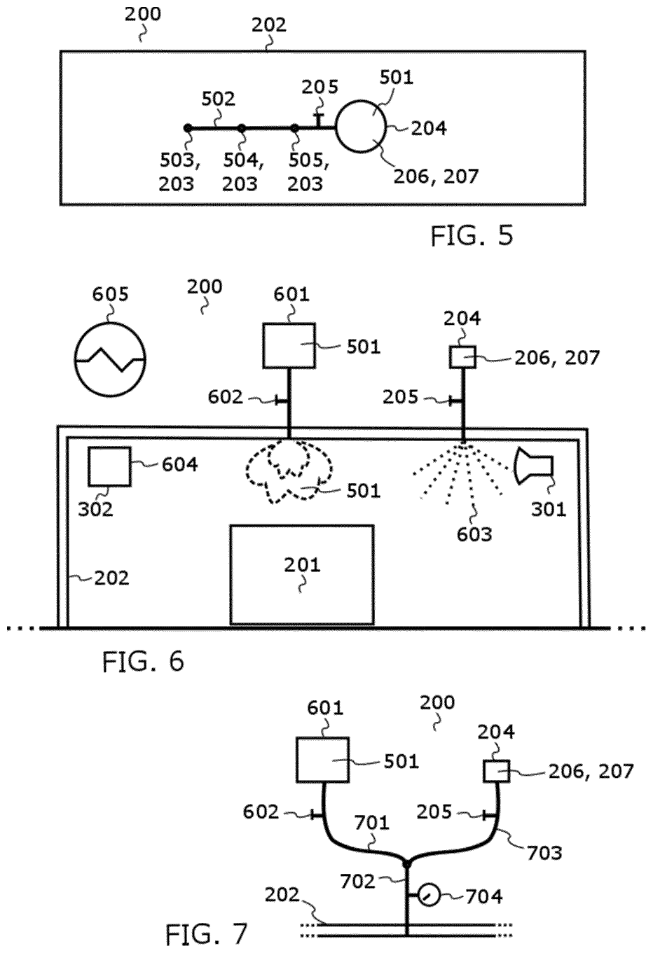

FIG. 5 shows from a bird's perspective leading treatment agent 207 into modification unit 202. In this embodiment of modification arrangement 200, fluid container 204 is intended for water 501 as well as treatment agent 207 and fluid container 204 is one of the following fluid storages: a liquid tank, a pressure cooker, a steam generator. Fluid 206 inside fluid container 204 includes treatment agent 207 that is water-soluble.

Fluid container 204 is coupled via control valve 205 to a fluid pipe 502. Fluid pipe 502 comprises at least one fluid aperture 203 for leading treatment agent 207 along with water 501 into modification unit 202. In this example, fluid pipe 502 comprises three nozzles 503-505 extending into modification unit 202 and as many fluid apertures.

FIG. 6 shows an inter-section of modification unit 202 and illustrates leading treatment agent 207 in aerosol form into modification unit 202. In this embodiment modification arrangement 200 comprises a steam generator 601 for cooling hygroscopic material 201 with water 501 and a watering valve 602 is coupled to steam generator 601. Control valve 205 controls leading fluid 206 from fluid container 204 into modification unit 202 and treatment agent 207 is included in fluid 206.

The embodiment enables the following use options: a) water 501 is used for the cooling without treatment agent 207, b) treatment agent 207 is used without water 501, and c) treatment agent 207 is simultaneously used with water 501. The option b) is useful when fluid container 204 includes solvent and treatment agent 207 is solvent based.

In one embodiment watering valve 602 and/or control valve 205 is an on/off valve.

In one embodiment watering valve 602 and/or control valve 205 is a gradually openable/closable valve.

In one embodiment treatment agent 207 is lead in aerosol form (through a fluid aperture) into modification unit 202. Dots in the figure illustrate aerosols, including an aerosol 603. Blower 301 is placed such that it is able to mix the aerosols and water 501, which is water steam, throughout the interior of modification unit 202.

Treatment agent 207 includes in many use cases the preservative. The preservatives usable in modification arrangement 200 can be categorized to solvent borne preservatives and water-borne preservatives. In one embodiment, a solvent borne preservative includes creosote and/or copper. In another embodiment, a water-borne preservative includes copper chrome arsenic, copper chrome boron, acid cupric chrome, zinc, oxide copper, copper naphthenic acid, glycol, and/or a silicate.

In one embodiment heater 301 is a radiator 604 that has a liquid circulation. When using oil in the liquid circulation, radiator 604 can be heated up to 500 C. °. In one embodiment the liquid circulation is coupled to a heat exchanger 605 and the heat energy, which is created e.g. for wood processing, is lead in a pipe into the heat exchanger 605 (the piping is omitted from the figure). The benefit of this embodiment is that radiator 604 can be heated in an environment-friendly manner by utilizing the waste heat.

FIG. 7 shows mixing of water 501 and treatment agent 207 before modification unit 202. Water 501 (herein water steam) is stored in steam generator 601. Steam generator 601 is coupled with a water pipe 701 and watering valve 602 to a mixing pipe 702. Treatment agent 207 is included in fluid 206 which is stored in fluid container 204. Fluid container 204 is coupled with a fluid pipe 703 and control valve 205 to mixing pipe 702.

If watering valve 602 is open and control valve 205 is open, water 501 ends into mixing pipe 702 and fluid 206 ends into mixing pipe 702. Then water 501 is added to fluid 206 and fluid 206 including water 501 is lead through at least one fluid aperture 203 into modification unit 202.

A benefit of this embodiment is that mixing pipe 702 provides in modification arrangement 200 such place for a concentration meter 704 that concentration meter 704 can meter the concentration of treatment agent 207 in fluid 206. Due to watering valve 602 and control valve 205, the concentration of treatment agent 207 in fluid 206 is adjustable by opening and closing control valve 205 and/or watering valve 602.

Modification arrangement 200 includes the following benefits, which relate to one or more figures and embodiments described in the above.

One benefit of modification arrangement 200 is that even underrated wood species are usable in many wood products when they are processed with modification arrangement 200. The processing enhances the hardness, strength, and abrasion properties of the timber made of those underrated wood species.

Another benefit is that modification arrangement 200 is energy-efficient, because modification arrangement 200 is usable in a normal atmospheric pressure and because the modification time is short compared to the prior art solutions.

Another benefit is that, in addition to the hardness, strength, and abrasion, also other properties can be modified. The other properties are a large colour palette and enhanced durability against any kind of wood damage. The colour of timber can be set by using a dye or a pigment in the process. Modification arrangement 200 makes the timber more durable and weatherproof when using preservative and/or an impregnation ingredient in the process.

Another benefit is that an excessive use impregnation or preservation ingredients is avoided by using modification arrangement 200.

Most of the embodiments, features, and examples described in the above can be combined themselves. The invention is specified in the following claims.

1. A modification arrangement for hygroscopic material, the modification arrangement comprising
a modification unit,
at least one fluid aperture in the modification unit, and
a fluid container that is coupled with a control valve to said at least one fluid aperture, and
in the modification arrangement
the hygroscopic material is heated in the modification unit in a normal atmospheric pressure to extract water from the hygroscopic material and, in response to opening of the control valve, fluid is conveyed from the fluid container through said at least one fluid aperture into the modification unit, for cooling of the hygroscopic material in the modification unit,
characterized in that the modification arrangement further comprises
a treatment agent added into the fluid so that inside the modification unit the treatment agent is absorbed, along with the fluid, into the hygroscopic material and modifies the hygroscopic material, and the treatment agent includes at least one of the following ingredients: a preservative, a dye, a pigment, an aroma, an odor eliminator, a pesticide, an impregnation ingredient, a fire retardant.

2. The modification arrangement as claimed in claim 1, characterized in that in the modification arrangement is configured for heating the hygroscopic material such that the modification unit is a drying oven which is able to heat air and circulate the air heated inside the modification unit.

3. The modification arrangement as claimed in claim 1, characterized in that the modification arrangement comprises a heater and a blower for heating the hygroscopic material inside the modification unit such that the blower is able to blow air towards the heater.

4. The modification arrangement as claimed in claim 1, characterized in that the modification arrangement comprises at least one of the following meters to determine a time for beginning of said conveying the fluid: a thermometer in the modification unit, a hygrometer in the modification unit, a clock.

5. The modification arrangement as claimed in claim 1, characterized in that the modification arrangement comprises a compression apparatus to apply an exertion of force upon the hygroscopic material such that water is extracted from the hygroscopic material.

6. The modification arrangement as claimed in claim 5, characterized in that the compression apparatus is a hydraulic press.

7. The modification arrangement as claimed in claim 1, characterized in in that the modification arrangement comprises a weight that is moveable on the hygroscopic material such that an exertion of force caused by the weight extracts water from the hygroscopic material.

8. The modification arrangement as claimed in claim 7, characterized in that the weight comprises a pallet, weight material and thermal insulation around the weight material.

9. The modification arrangement as claimed in claim 1, characterized in that in the modification arrangement the modification unit comprises a bottom part and a top part that are detachable from each other.

10. The modification arrangement as claimed in claim 1, characterized in that in the modification arrangement the fluid container is adapted to contain the treatment agent and water.

11. The modification arrangement as claimed in claim 1, characterized in that the modification arrangement comprises a steam generator for cooling the hygroscopic material with water and a watering valve coupled to the steam generator.

12. The modification arrangement as claimed in claim 1, characterized in that in the modification arrangement the treatment agent is lead in aerosol form into the modification unit.

13. The modification arrangement as claimed in claim 13, characterized in that in that the heater is one of the following apparatus: an electrical resistance pack, a radiator having a liquid circulation.

14. The modification arrangement as claimed in claim 1, characterized in that a steam generator is coupled via a watering valve to a mixing pipe and a fluid container is coupled via the control valve to the mixing pipe.

15. The modification arrangement as claimed in claim 1, characterized in that the treatment agent includes at least one of the following ingredients as the preservative: creosote, copper, copper chrome arsenic, copper chrome boron, acid cupric chrome, zinc, oxide copper, copper naphthenic acid, glycol, a silicate.
